(19) United States
(12) Patent Application Publication
(10) Pub. No.: US 2005/0183549 A1
(43) Pub. Date: Aug. 25, 2005

(54) Multifunctional tool

(76) Inventor: Ching-Shin Chiang, Taichung Hsien (TW)

Correspondence Address: LAW OFFICE OF LIAUH & ASSOC., 4224 WAIALAE AVE, STE 5-388, HONOLULU, HI, 96816, US

(21) Appl. No.: 10/786,210

(22) Filed: Feb. 24, 2004

(51) Int. Cl. B25B 13/00

(52) U.S. Cl. 81/58

(57) ABSTRACT

A Y-shaped tool comprises a central member a ratchet based coupling having a square or hexagonal section projected from a bottom, the coupling being adapted to connect to a member having a tip of screwdriver, and connect to a mated slot at one end of a coupling sleeve which has the other end adapted to put on a fastener, and three peripheral slots each having a square section; and three removable handles each including a coupling member having a square section at one end and a sleeve tip at the other end adapted to put on a fastener. The coupling member is insertable into the mated slot to be fastened. One of the handles is replaceable by a shank having one end insertable into the mated slot for fastening and the other end shaped as a tip of screwdriver or the like.

### BACKGROUND OF THE INVENTION

1. Field of the Invention

The present invention relates to tools and more particularly to a multifunctional tool with improved characteristics.

2. Description of Related Art

There are a variety of tools. Also, for one type of tool, there are a variety of forms thereof. For example, the enclosed box portion (i.e., tip) of a sleeve wrench may be formed to work on a tetragonal or hexagonal head of a bolt or nut. For a screwdriver, it may have a flat tip, Robertson tip, or Phillips tip. It is typical that a tool is adapted to work on a single, predetermined article. This is illustrated in a prior sleeve wrench 1 in FIG. 1. The integral sleeve wrench 1 has a T-shaped handle 11 and a sleeve tip 12. The prior art thus suffered from a disadvantage. For example, a craftsman has to prepare a variety of forms of a single tool in the workroom for work. This inevitably may occupy precious space and make the workroom messy. Another prior art proposed to overcome the above disadvantage is shown in FIG. 2. The integral Y-shaped tool 2 comprises three handles 21 each having a different sleeve tip 22 adapted to work on a unique article. Such prior art can only, theoretically reduce the required forms of a wrench owned by a craftsman by two third. Thus, most of the above stated disadvantages are still not eliminated. Hence, a need for improvement exists.

### SUMMARY OF THE INVENTION

It is an object of the present invention to provide a multifunctional tool comprising a central member including a ratchet wheel on the top, a coupling having a square or hexagonal section projected from the bottom, the coupling being adapted to rotate in one direction only by operatively connecting to the ratchet wheel, and a plurality of peripheral slots each having a square section equally spaced apart around the central member; and a plurality of removable handles each including a coupling member having a square section at one end, a spring depressible detent on one side of the coupling member, and a sleeve tip at the other end, wherein the coupling member is adapted to insert into the mated slot with the detent fastened in a recess inside the coupling member.

In one aspect of the present invention the number of each of the slots and the handles is three.

In another aspect of the present invention the sleeve tip of the handle is shaped for being adapted to put on a fastener.

In still another aspect of the present invention the coupling is adapted to connect to a mated slot at one end of a coupling sleeve which has the other end adapted to put on a fastener.

In yet another aspect of the present invention one of the handles is replaceable by one of four different shanks each having one end insertable into the mated slot for fastening and the other end shaped as a Phillips tip of a screwdriver, a hexagonal tip, a sleeve tip, or a tetragonal tip.

In a further aspect of the present invention the coupling is adapted to couple to a member having a Phillips tip or flat tip of a screwdriver.

The above and other objects, features and advantages of the present invention will become apparent from the following detailed description taken with the accompanying drawings.

### BRIEF DESCRIPTION OF THE DRAWINGS

FIG. 1 is a perspective view of a conventional sleeve wrench;

FIG. 2 is a perspective view of another conventional Y-shaped tool including three integral sleeve wrenches;

FIG. 3 is an exploded view of a multifunctional tool according to the invention;

FIG. 4 is a perspective view of the assembled tool shown in FIG. 3; and

FIGS. 5, 6, 7 and 8 are perspective view for illustration of four different use states of the tool according to the invention.

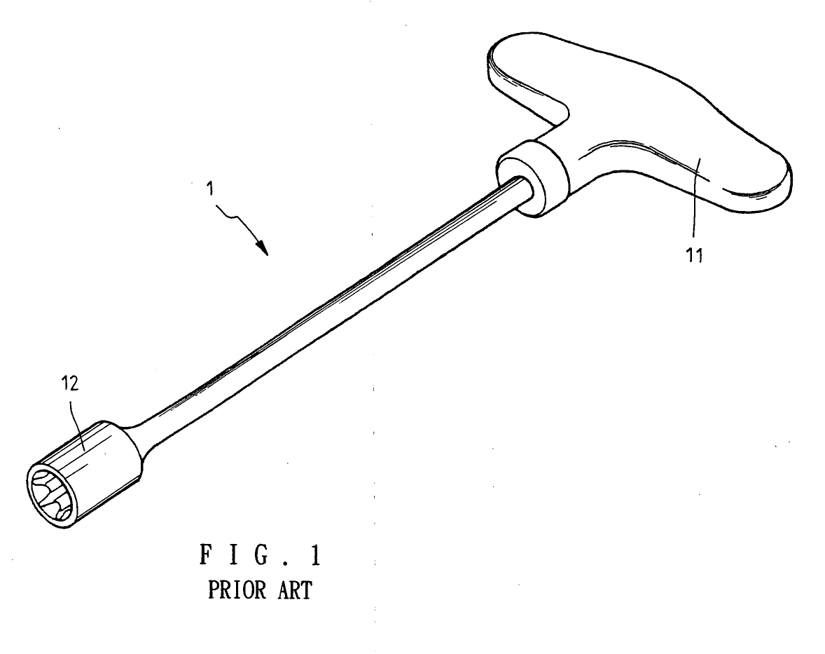

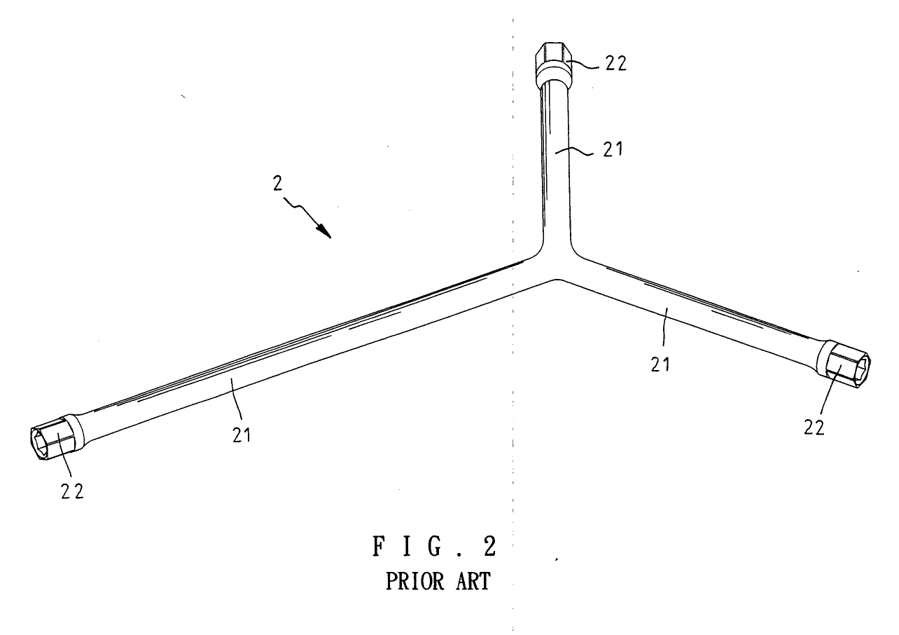

### DETAILED DESCRIPTION OF THE PREFERRED EMBODIMENTS

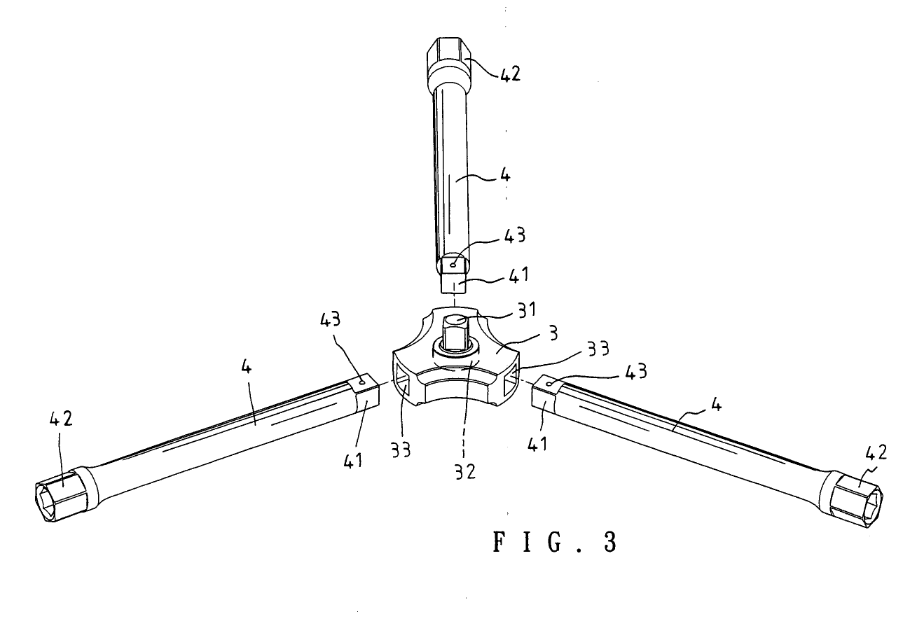

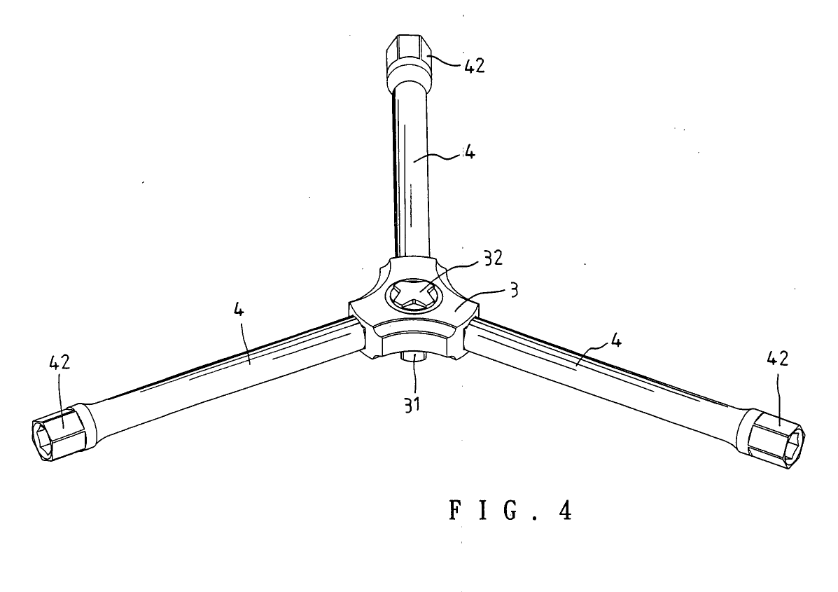

Referring to FIGS. 3 and 4, there is shown a multifunctional tool constructed in accordance with the invention. The Y-shaped tool comprises a central member 3 including a ratchet wheel 32 on the top, a coupling 31 having a square section (or hexagonal section in other embodiments) projected from the bottom, the coupling 31 being adapted to rotate in one direction only by operatively connecting to the ratchet wheel 32, and three peripheral slots 33 each having a square section equally spaced apart around the central member 3; and three releasable handles 4 each including a coupling member 41 having a square section at one end, a spring depressible detent 43 on one side of the coupling member 41, and a sleeve tip 42 at the other end, the sleeve tip 42 being adapted to work on a unique article. In assembly, the coupling member 41 is inserted into the mated slot 33 with the detent 43 fastened in a recess (not shown) inside the coupling member 41.

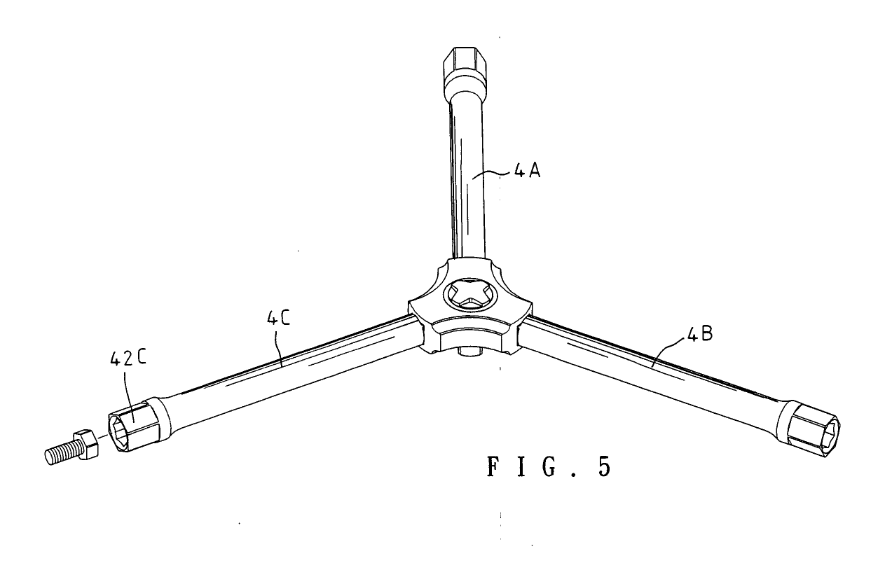

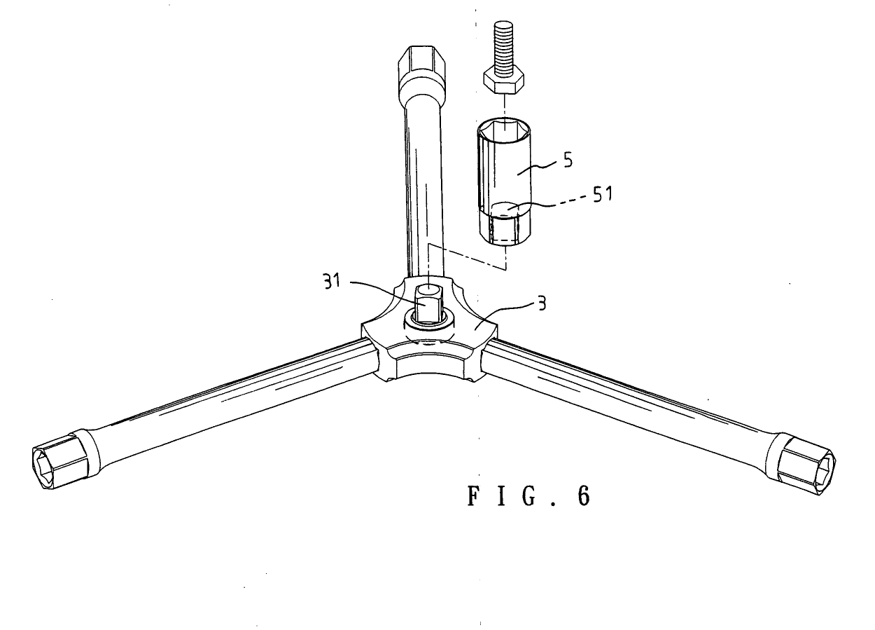

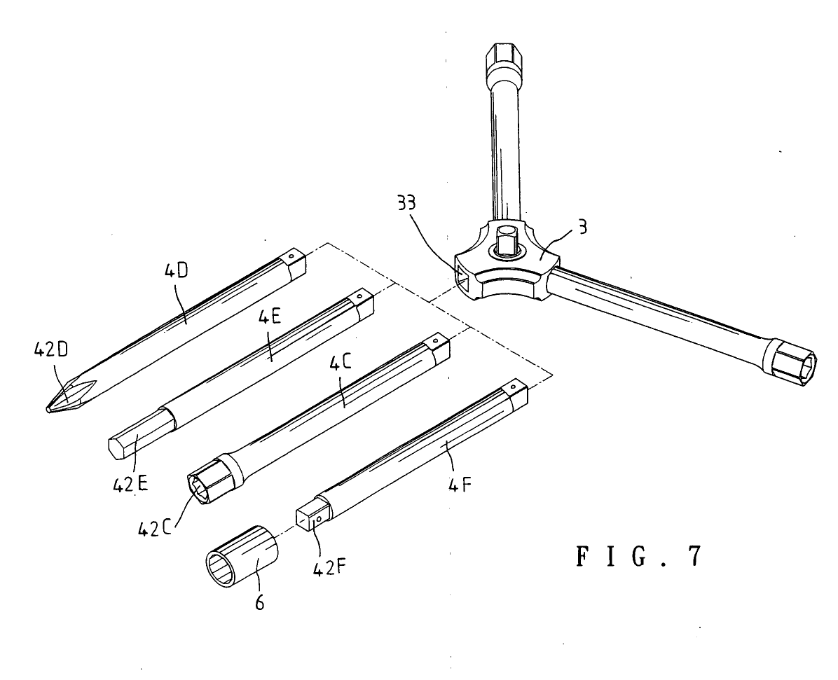

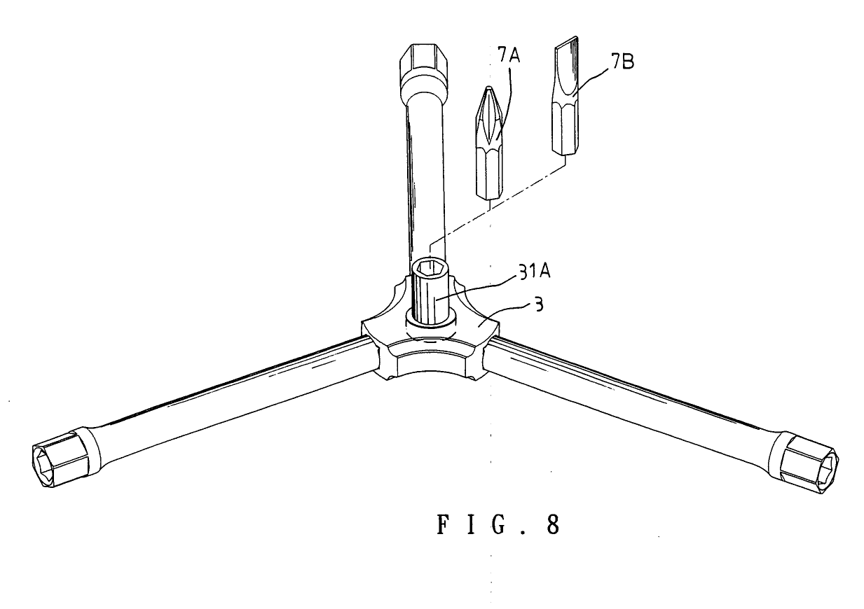

Referring to FIGS. 5 to 8, a number of use states of the tool the invention will now be described in detail below. As shown in FIG. 5, the sleeve tip 42C of the handle 4C is shaped for being adapted to put on a fastener (e.g., bolt). Once coupled, the handles 4A and 4B can be turned to fasten or unfasten the bolt. As shown in FIG. 6, the coupling 31 is about to connect to a mated slot 51 at one end of a coupling sleeve 5 which has the other end adapted to put on a bolt. Once coupled, one or more handles can be turned to fasten or unfasten the bolt. As shown in FIG. 7, one of the handles is replaced by one of four shanks 4A, 4B, 4C, and 4D different from the original one. Each shank has one end insertable into a mated slot 33 for fastening and the other end shaped as a Phillips tip 42D of a screwdriver, a hexagonal tip 42E, a sleeve tip 42C, or a tetragonal tip 42F adapted to couple to a coupling sleeve 6 which has the other end adapted to put on the head of a fastener (e.g., bolt). Once the shank and an article to be worked are coupled, the other two handles can be turned to fasten or unfasten the article. As shown in FIG. 8, the coupling 31A is about to couple to a member having a Phillips tip 7A or flat tip 7B of a screwdriver. Once coupled, one or more handles can be turned to fasten or unfasten an article being worked by the Phillips tip 7A or flat tip 7B.

While the invention herein disclosed has been described by means of specific embodiments, numerous modifications and variations could be made thereto by those skilled in the art without departing from the scope and spirit of the invention set forth in the claims.

1. A tool, comprising:
a central member including a coupling projected from a bottom, and a plurality of peripheral slots equally spaced apart around the central member; and
a plurality of removable handles each including a coupling member at one end and a sleeve tip at the other end,
wherein each of the coupling members is adapted to insert into the corresponding one of the slots for coupling.

2. The tool of claim 1, wherein each of the coupling member and the slot has a square section.

3. The tool of claim 1, wherein the central member further comprises a ratchet wheel on a top, and the coupling has a square section, the coupling being adapted to rotate in one direction only by operatively connecting to the ratchet wheel.

4. The tool of claim 2, wherein the coupling member comprises a spring depressible detent on one side and the slot has an internal recess for matingly coupling to the detent when the coupling member is inserted into the slot.

5. The tool of claim 1, wherein the central member further comprises a ratchet wheel on a top, and the coupling has a hexagonal section, the coupling being adapted to rotate in one direction only by operatively connecting to the ratchet wheel.

6. The tool of claim 1, wherein the coupling member includes first means and the slot includes second means for matingly coupling to the first means when the coupling member is inserted into the slot.

7. The tool of claim 6, wherein the first means is a spring depressible detent and the second means is an internal recess.

8. The tool of claim 1, wherein the number of each of the slots and the handles is three.
